(19) United States
(12) Patent Application Publication
(10) Pub. No.: US 2003/0164095 A1
(43) Pub. Date: Sep. 4, 2003

(54) Air filter with resistive screen

(76) Inventor: Constantinos J. Joannou, Nepean (CA)

Correspondence Address: David J. French, Stn. "D", P.O. Box 2486, Ottawa, K1P 5W6, CA

(21) Appl. No.: 10/085,093

(22) Filed: Mar. 1, 2002

(51) Int. Cl. B03C 3/01

(52) U.S. Cl. 96/59

(57) ABSTRACT

An electric polarizing air filter has a charged screen of high resistivity to suppress avalanche discharge and permit use of a higher polarizing voltage.

### FIELD OF THE INVENTION

This invention relates to gas and air filtration systems. In particular, it relates to the removal of fine particulates from gaseous flows.

### BACKGROUND OF THE INVENTION

In the previous art, electronic air filters of the charge media type, filter media are positioned between metal screens and polarized by applying high voltage between these screens. Examples are is my U.S. Pat. No. 4,549,887 and U.S. Pat. No. 4,828,586. These inventions effectively describe filters which have two outside grounded screens and an inside screen which is charged with high voltage. Between the screens there are pads of dielectric fibrous trapping material which becomes polarized by the electric field between the screens.

The amount of voltage which can be applied between these screens is limited by the space between the screens. Typically for a one-inch thick filter, the applied voltage is approximately 7 kilovolts. If the voltage is increased beyond this, avalanche arcing occurs between the inside screen and the outside grounded screens. This produces a loud sparking noise. Avalanche discharge occurs when a small leakage starts which ionizes the air and generates a conductive path between the screens at one spot. This causes the charge on the inside screen to dissipate abruptly thus making the loud noise. The effect is intense because the inside screen and the outside screens form a capacitor with the dielectric media being the dielectric. The experience is disconcerting for users.

U.S. Pat. No. 5,573,577, by the same inventor, describes a similar filter where conductive strings are used in place of the inside screen. These strings feature loose fiber ends and they are rendered conductive by some means. In this case, avalanche discharge is very minimal because the strings, by their small total surface area have very small capacitance. In practice, they are about 1-¼ inches apart the purpose of using the strings is to provide internal ionization via the loose ends of the fibers. The actual area covered by the strings is much smaller as compared to the area covered by an equivalent screen. This is why the strings have very small capacitance.

In view of the foregoing, it is the object of my present invention to eliminate avalanche discharge in these filters and also enable application of higher voltage between the screens, which results in higher efficiency of the filter.

### SUMMARY OF THE INVENTION

The invention herein is based on providing charged screens in charged media type filters where these screens are made of resistive materials like plastic mesh which is conductive, but is made to have high resistance to current flow. It was found that if a charged screen has high resistivity, a small leakage current between the charged screen and the outside grounded screens causes the voltage at that point to decrease. The voltage drop occurs when current flows through the resistance. (V=IR). This prevents a large discharge. Also the high resistivity of the screen will prevent the rest of the screen from discharging very rapidly. Therefore, by using resistive charged screens, the applied voltage can be increased thus improving the efficiency of the filter.

In my present invention, by using highly resistive screen, the area covered by the screen is the same as with a metal screen but because of the screens high resistivity, avalanche discharge is eliminated. In this way, we get good polarization, because of the large area covered with no avalanche discharge.

The foregoing summarizes the principle features of the invention. The invention may be further understood by the description of the preferred embodiments and drawings which now follow.

### BRIEF DESCRIPTION OF THE FIGURES AND TABLE

FIG. 1 is a perspective view showing a typical arrangement of a prior art charged media type, filter before a resistive screen according to the invention is installed.

FIG. 2 is part of the arrangement of FIG. 1 showing a leakage current at the corner of the filter with a resistive screen electrode present, according to the invention.

FIG. 3 is a graph showing the voltage distribution across the resistive screen of FIG. 2 when leakage current occurs.

FIG. 4 is a graph showing the improvement in efficiency of a filter using the higher voltage permitted by a resistive screen as compare to one using a metal screen.

Table 1 is a listing of particle counts, corresponding to Table 4, showing a comparison of the trapping efficiency of a filter with a resistive central screen according to the invention as opposed to a filter with a prior art, metal central screen.

### DESCRIPTION OF THE PREFERRED EMBODIMENT

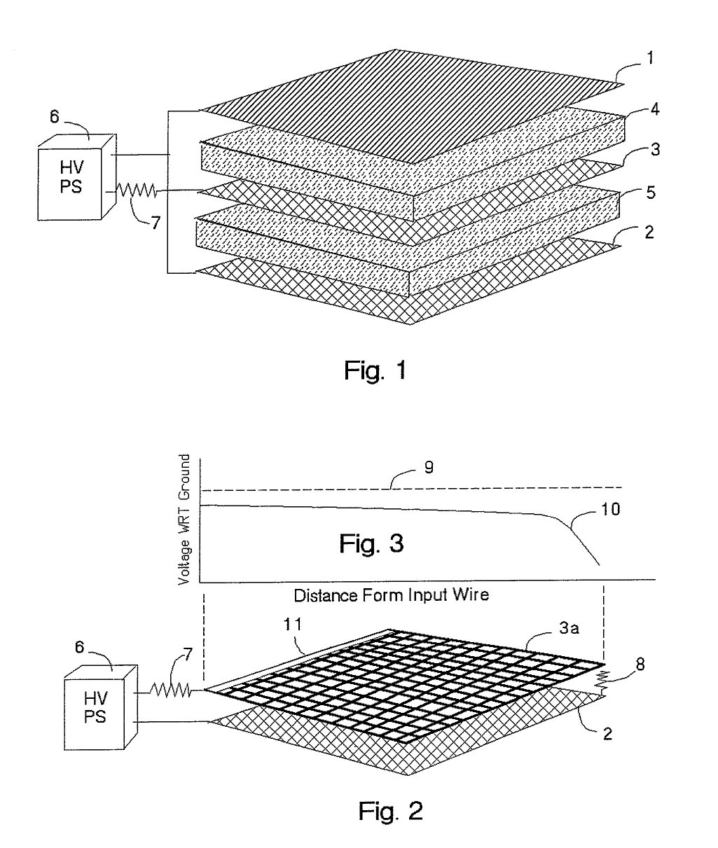

FIG. 1 shows a typical arrangement of a charged media type electronic air filter. Outside screens 1 and 2 are electrically grounded. A central screen 3 is charged to high voltage from power supply 6. The high voltage applied between the screens 1 2, and 3, generates an electrostatic field which polarizes the dielectric filter media 4 and 5. Although two outer screens and two filter media are shown, a filter assembly could have only on medium e.g. 5, and adjacent screens 2,3.

The polarization of the media 4,5 forms positive and negative surface charges on the media fibers, which in turn attract dust.

In the prior art charged media filters, the inside screen 3 is made of metal, which forms a capacitor between it and the outside screens 1 and 2. If by some reason the media 4 and 5 or the surrounding air becomes leaky and a small amount of current flows between the screens, this leakage ionizes the surrounding air which forms a conducting path. As a result, the charge on the central screen 3 starts to flow through the path and more and more current flows. This produces more ionization of the air and more conduction etc and finally the whole charge on the central screen 3 discharges with a spark. This is what is called avalanche discharge.

As a consequence of this phenomenon, the voltage that can be applied to the central screen 3 is limited to about 7 kV in the case of a one-inch filter. To eliminate the avalanche effect and to be able to apply higher voltage to the central screen 3, the central screen 3 can be made of a high resistivity material such as a slightly conducting plastic. FIG. 2 shows a central screen 3a which is made of plastic or the like that has high resistivity.

To illustrate the effect of this arrangement, FIG. 2 shows the power supply 6 connected to one end of the high resistivity screen 3a via conductive bus bar electrode 11. Electrode 11 is used to distribute the voltage over a greater surface of the resistive screen 3a in order to minimize voltage drop at the input to the screen of leakage current. FIG. 2 also shows a current leakage 8 to the grounded screen 2 at the opposite corner. In this case, the moment some leakage occurs, the voltage on the central screen 3a around the leakage 8 will drop. Because of the resistance of the screen 3a the leakage 8 will be minimized. No avalanche discharge can occur because the resistance of the resistive screen 3a limits current to the leakage point 8. If there is no leakage current, the central resistive screen 3a will acquire the full voltage of the power supply. Thus polarization at this full potential can be created.

A test sample of resistive screen 3a was prepared from a plastic mesh of 8 thousandths inch thickness. Within the mesh the pitch interval was about 0.125 inches, with hexagonal openings of about 0.120 inches in width. This mesh was carbonized by dipping it in a solution of colloidal graphite containing a binder within the liquid. The liquid was evaporated leaving a carbon coating on the mesh.

A square foot sample of the resistive screen 3a was measured as having a resistance from one side across to the other side of 300 megohms.

FIG. 3 shows the voltage distribution along the central resistive screen 3a between the point where the power supply is connected and the leakage point 8. If there is no leakage, the voltage profile will be constant, that of the power supply, curve 9. If there is a leakage 8, the voltage profile will be that of curve 10. Notice that there is a small voltage drop from the supply voltage even at the point of power supply connection. This is the IR drop in the power supply internal resistance 7. At the leakage point 8, the voltage drops much more due to the high resistivity of the central resistive screen 3a.

Accordingly, by making the central resistive screen 3a with a high resistivity material, we can apply higher charging voltage which produces higher degree of polarization which, in turn, increases the filter's efficiency.

Test Results

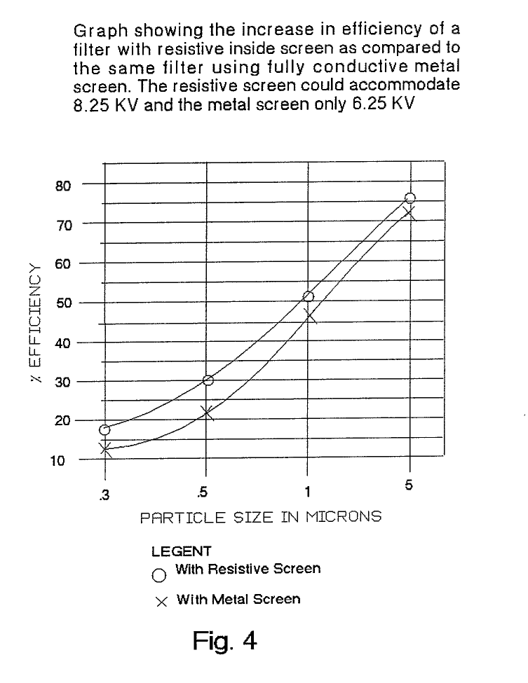

The following Table and the graph of FIG. 4 shows: results of tests made on an identical filter, one with an inside screen 3 made completely conducting metal mesh and one with a resistive plastic mesh as its screen 3a. The metal mesh 3 could accommodate only 6.25 KV before avalanche sparking occurred. The resistive screen 3a could accommodate 8.25 KV. A higher voltage than that would cause excessive discharge but no avalanche sparking occurred. As it can be seen from the test results, the resistive screen 3a has a better overall efficiency due to the higher voltage applied as compared to the filter with the metal screen 3.

Conclusion

The foregoing has constituted a description of specific embodiments showing how the invention may be built and put in use. These embodiments are only exemplary. The invention in its broadest, and more specific, aspects is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

| | | | | | | |
|---|---|---|---|---|---|---|
| .3 | % | .5 | % | 1 | % | 5 |
| micron | Eff | microns | Eff | micron | Eff | micron |

Test With metal screen at 6.25 KV Air Velocity = 300 ft/min

| | | | | | | | | |
|---|---|---|---|---|---|---|---|---|
| u/s | 7235 | | 1585 | | 389 | | 49 | |
| d/s | 6503 | 10.91 | 1217 | 24.32 | 219 | 46.19 | 12 | 74.47 |
| u/s | 7364 | 10.26 | 1631 | 20.32 | 425 | 44.94 | 45 | 70.00 |
| d/s | 6714 | 12.67 | 1382 | 19.25 | 249 | 46.39 | 15 | 70.87 |
| d/s | 8012 | 12.52 | 1792 | 17.08 | 504 | 44.54 | 58 | 70.69 |
| u/s | 7304 | 15.47 | 1590 | 26.93 | 310 | 51.98 | 19 | 75.95 |
| d/s | 9269 | | 2560 | | 787 | | 100 | |
| | Average | 12.37 | Average | 21.58 | Average | 46.81 | Average | 72.40 |

Test With resistive screen at 8.25 KV Air Velocity = 300 ft/min

| | | | | | | | | |
|---|---|---|---|---|---|---|---|---|
| u/s | 6272 | | 939 | | 250 | | 39 | |
| d/s | 5071 | 17.18 | 542 | 38.51 | 113 | 55.07 | 11 | 73.17 |
| u/s | 5974 | 15.14 | 824 | 32.58 | 253 | 54.94 | 43 | 77.91 |
| d/s | 5068 | 15.37 | 569 | 31.36 | 115 | 51.37 | 8 | 80.49 |
| d/s | 6003 | 14.82 | 834 | 25.30 | 220 | 47.05 | 39 | 71.79 |
| u/s | 5159 | 15.83 | 677 | 21.05 | 118 | 49.03 | 14 | 67.44 |
| d/s | 6255 | | 881 | | 243 | | 47 | |
| | Average | 15.67 | Average | 29.76 | Average | 51.49 | Average | 74.16 |

I claim:

1. An electronic air filter of the charged media type comprising at least an outer screen and at least one charged screen adjacent said outer screen, said screens having dielectric trapping media positioned there between, said charged screen being made of a material that exhibits high resistivity sufficient to suppress avalanche discharge between said screens.

2. An electronic air filter of the charged media type as described in claim 1 wherein the charged screen has a border and comprising a contacting electrode by which said voltage is supplied to said charged screen, positioned along said border for better distribution of the applied voltage across said charged screen.
